(19) United States
(12) Patent Application Publication
(10) Pub. No.: US 2010/0172287 A1
(43) Pub. Date: Jul. 8, 2010

(54) TEMPORAL NETWORK SERVER CONNECTED DEVICES WITH OFF-LINE AD HOC UPDATE AND INTERACTION CAPABILITY

(76) Inventor: Marcus Krieter, Newport Beach, CA (US)

Correspondence Address: Maulin V. Shah, Esq., 1375 Broadway, Third Floor, New York, NY, 10018, US

(21) Appl. No.: 12/255,667

(22) Filed: Oct. 22, 2008

Related U.S. Application Data
(60) Provisional application No. 60/982,422, filed on Oct. 25, 2007.

(51) Int. Cl. H04W 4/00

(52) U.S. Cl. 370/328

(57) ABSTRACT

A system and method for using mobile network devices that are periodically connected to a network server are disclosed. The devices exchange data in an ad hoc manner when not connected to the server. In the preferred embodiment, independent mobile wireless network devices are connected to a network server through a client computing device acting as a gateway to the server. The presence of the mobile network device and the client computing device cause both devices to become users. The server pairs both the network device and the client computing device with a unique identity contained on the network device. Paired and independent identities that have presence on the server then interact with each other in such a manner that data on the connected mobile network devices is changed and stored in concordance with this community interaction. Unconnected mobile network devices search for other unconnected mobile network devices within range to form an ad hoc network. This allows the mobile network devices to exchange and store data related to their last community server interaction. This data is context specific in terms of the specific services used by the by the users that had presence on the community server. User interaction directly with mobile network devices can change this information locally even when not connected to a client computer. This information will also be exchanged and affect data stored on mobile devices that are part of an independent ad hoc network according to the context of the previous server data stored on the mobile devices.

### CROSS REFERENCE TO RELATED APPLICATIONS

This application claims the benefit of 35 U.S.C. §119 and the filing date of provisional application 60/982,422, filed Oct. 25, 2007.

### FIELD OF INVENTION

The present invention relates to the field of computer networking. More specifically, the invention relates to computer-controlled devices that possess interaction and self-initiated update capabilities.

### BACKGROUND OF THE INVENTION

The proliferation and adoption of community networks and services continues to expand dramatically. Excellent examples of this are the Massively Multiplayer Online Roll-Play Gaming (MMORPG) communities that have enjoyed success in online. Mobile and fixed network access devices spanning highly mobile devices such as mobile phones to fixed PC workstations all provide access to these communities whereby community members can interact with other members and with virtual characters and entities within their community. These members, virtual characters and entities form a virtual space. Mobile and fixed network access devices merely act upon a virtual space by facilitating user access. Hence, this current state of the art is limited. In only acting upon the virtual space, it does not allow for physical devices to actually become the part of a universal space comprised of both the virtual space and characters and entities that have physical form and exist in physical space. The ubiquitous intertwining of these two spaces into one provides a unique advantage over the current state of the art.

### SUMMARY OF THE INVENTION

A system and method for mobile network devices that are periodically connected to a network server and updated and also exchange data in an ad hoc manner when not connected to the server is disclosed. In the preferred embodiment, simple independent mobile wireless network devices are connected to a community network server, either through wireless or wired means, through a client computing device acting as a gateway to the community server. The presence of the mobile network device and presence of the client computing device cause both devices to become users of the community server. The community server pairs both the network device and the client computing device with a unique identity contained on the network device. A client computing device may also have an independent identity on the community server if no mobile network device is connected to it. Paired and independent identities that have presence on the community server then interact with each other through community server services in such a manner that data on the connected mobile network devices is changed and stored on the mobile network devices in concordance with this community interaction. When mobile network devices are not connected with the client computing device, they search for other unconnected mobile network devices and form an ad hoc network with devices that are in range. When this server and client computing system independent ad hoc network is established, the mobile network devices exchange and store data related to their last community server interaction. This data is context specific in terms of the specific services used by the by the users that had presence on the community server. User interaction directly with mobile network devices can change this information locally on the mobile network device even when not connected to a client computer. This information will also be exchanged and affect data stored on mobile devices that are part of an independent ad hoc network according to the context of the previous server data stored on the mobile devices.

### BRIEF DESCRIPTION OF THE DRAWINGS

FIG. 1 illustrates a basic system component topology of the preferred embodiment of the present invention.

FIG. 2 illustrates an expanded system component topology of the ad hoc network comprised of new mobile network devices that have more recent data than previously shown in FIG. 1 of the preferred embodiment of the present invention.

FIG. 3 illustrates an internal architecture of the client computational device of the preferred embodiment of the present invention.

FIG. 4 illustrates a network architecture and data interaction between the network server and client side software of the preferred embodiment of the present invention.

FIG. 5 illustrates one embodiment of the hardware schematic for the mobile network device of the present invention.

FIG. 6 illustrates an alternative hardware embodiment for the mobile network device of the present invention.

FIG. 7 illustrates key components of the MCU memory of the preferred embodiment of the present invention.

FIG. 8 illustrates a hardware schematic for the MCU of FIG. 7 of the preferred embodiment of the present invention.

FIG. 9 illustrates a client gateway application program operating in conjunction with its database under the control of a very thin operating system in the preferred embodiment of the present invention.

FIG. 10 illustrates a virtual community of virtual components to be used in conjunction with the preferred embodiment of the present invention.

FIG. 11 illustrates a virtual chat community of virtual and physical elements, motion command emoticons and a text entry field to be used in conjunction with the preferred embodiment of the present invention.

FIG. 12 illustrates a virtual purchase community comprised of virtual elements to be used in conjunction with the preferred embodiment of the present invention.

### DETAILED DESCRIPTION OF THE PREFERRED EMBODIMENT

In the following description of the various embodiments, reference is made to the accompanying drawings, which form a part hereof, and in which is shown by way of illustration, various embodiments in which the invention may be practiced. It is to be understood that other embodiments may still be utilized and structural and functional modifications may be made without departing from the scope and spirit of the present invention.

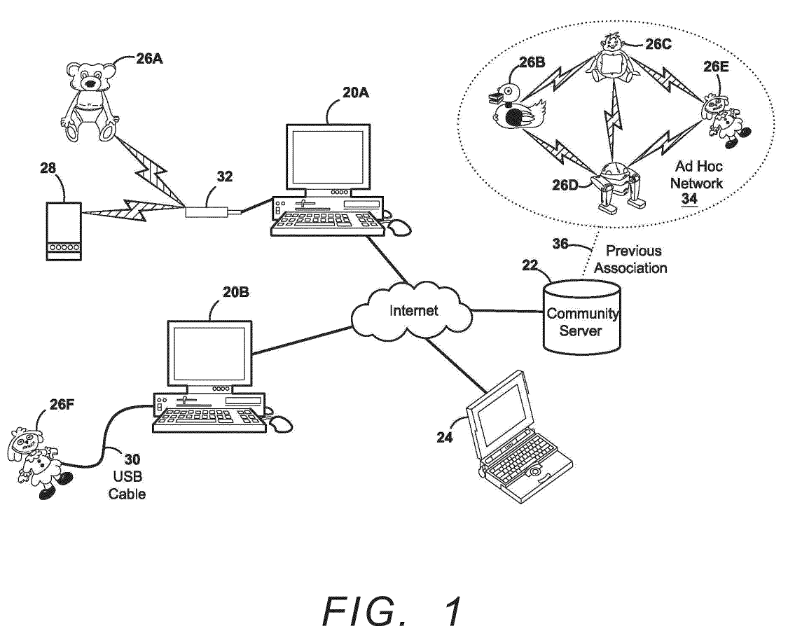

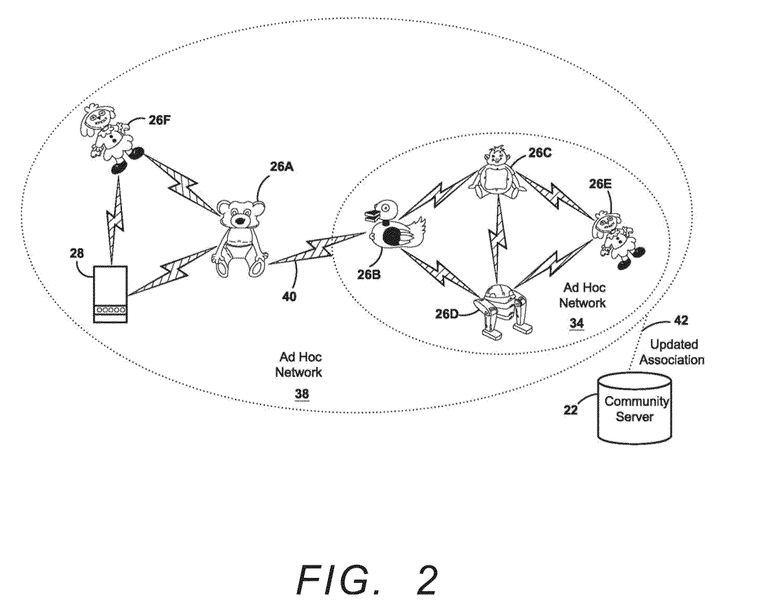

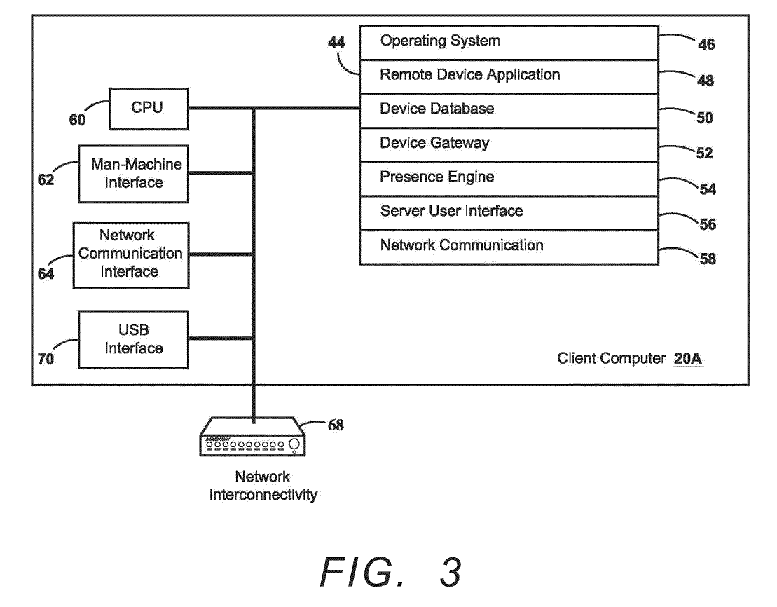

Referring to FIG. 1, a basic functional topology of the preferred embodiment is shown. Two client computational devices 20A and 20B that act as gateway devices providing access to a community server 22 via the internet, or alternatively any other internal or public computer network and also provide user interfaces to the community server. Another client 24 that does not act as a gateway but provides user interfaces alone is also shown in this system embodiment. The clients have the hardware and software architecture shown in FIG. 2 and the network handling architecture shown in FIG. 3. The number of clients and client-gateways is limited only by the capability of the community server. Only three such clients are shown for simplicity of example. In a deployed system the number of client computational devices could attain numbers beyond present-day internet servers. The community server provides services to the clients such as instant messaging, chat rooms, presence management including buddy lists, massive multiplayer games, text messaging, networked robot control, multimedia databases, electronic commerce, file transfer support, web page support and administration. Such services are not limited to the latter as the server is highly extensible. The foundation for such servers is well established and is implemented with existing engines as required for the specific service.

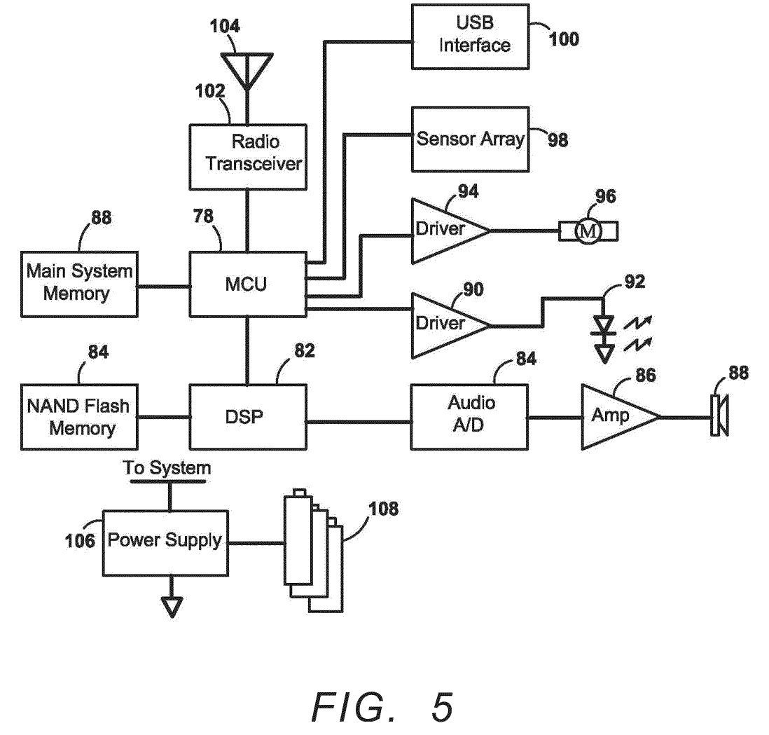

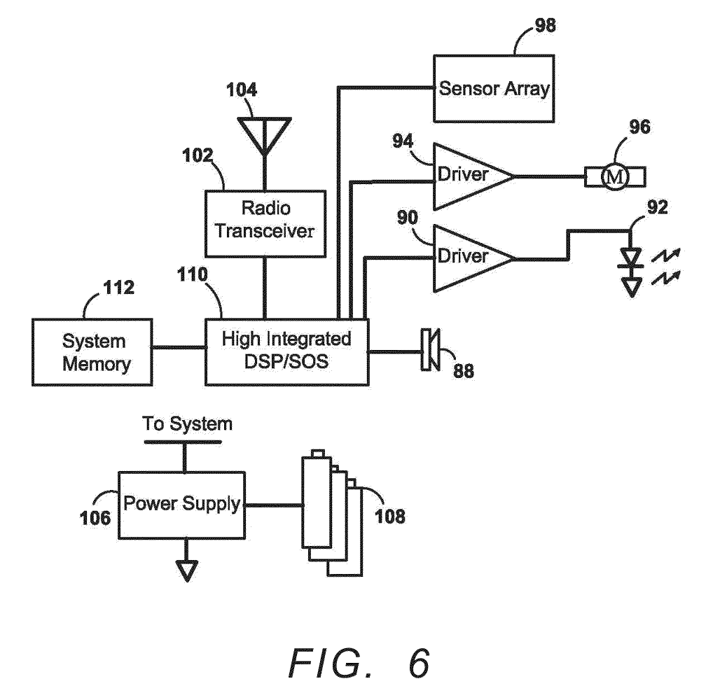

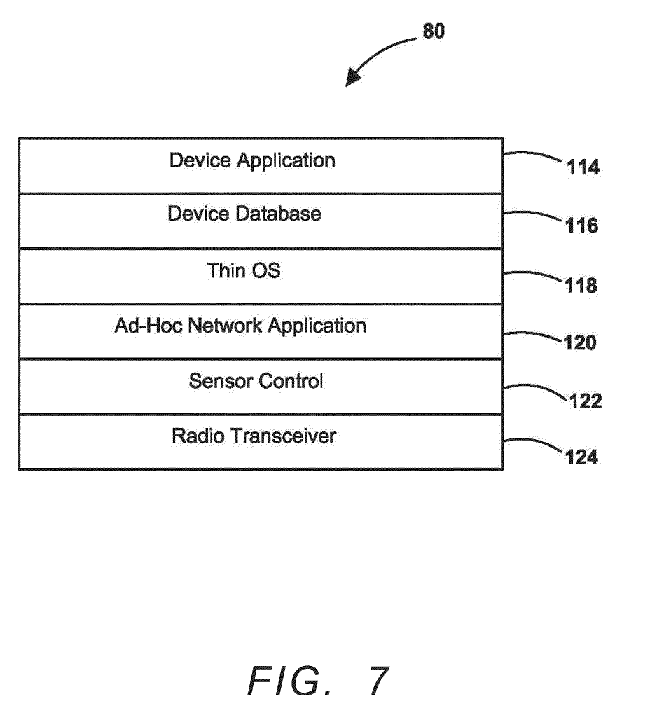

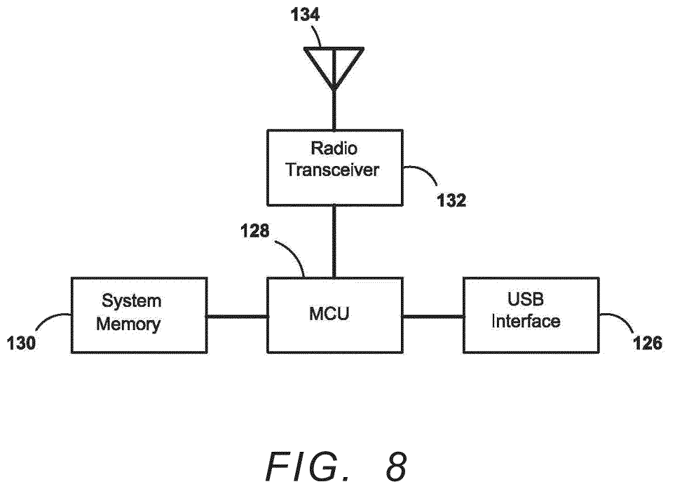

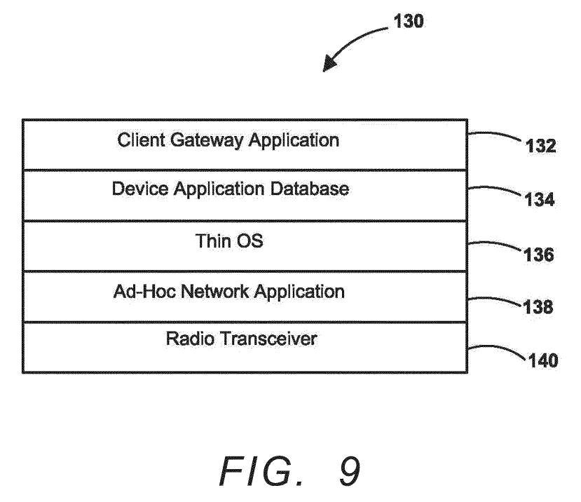

Mobile network devices 26A through 26F are shown having external packaging (personalities) resembling plush or hard toy objects. These are exterior cosmetic details as the interior software architecture is the same as shown in FIG. 7 and the interior hardware architecture is the same as shown in FIG. 6 that is an alternative but functional equivalent to FIG. 5. These network devices are not limited to toys and can be physically and functionally expanded or simplified significantly. A mobile network device 28 is shown that is compatible with the system and other network devices but renders its personality virtually on a graphics display. Such devices could be, but are not limited to, off-the-shelf computational devices such as personal digital assistants, cell phones and other portable network clients. They could also be custom devices that range from simple Tamagotchi® or Tamagotchi®-like devices to computational devices with high-end monochrome or color graphics rendering technologies. Mobile devices 26A through 26E and 28 show wireless connectivity. This wireless connectivity can be radio frequency, optical including the infrared and visual spectrums and acoustic. USB cable 30 connects mobile device 26F to the client shown. Although the physical protocol complies with USB standards, the client still acts as a gateway over this link to provide an identical interaction with the server. USB access point 32 is a serial to RF converter that translates and transcodes the USB serial data on the client to the RF network and RF protocol used by the mobile network devices. The USB device has the same architecture shown in FIG. 8 and the same software architecture as shown in FIG. 9.

Ad hoc network 34 is a self-configuring, self-organizing multi-hop ad hoc wireless network that all parties within range can establish communication. In this embodiment the network is wireless. However, wired serial networks are an alternative. For wireless, Dynamic Source Routing (DSR) protocol is used in this embodiment. The network does not require a hub and distributes routing dynamically based on the number of mobile network devices in range. Four devices are shown; however, the actual number can be as small as two and grow to hundreds of units. A logical link 36 shows the association between the entire ad hoc network and the community server. This logical link demonstrates that the complete ad hoc network contains data that is current to the last data available from the network device most recently connected to the community server.

Now referring to FIG. 2, an expanded ad hoc network 38 comprised of new mobile network devices that had more recent data than that of ad hoc network 34 is shown. Mobile devices 26A, 26F and 28 establish connection amongst themselves because of range limitations with respect to those of the original ad hoc network 34. The mobile device 26A creates hop connection 40 between these three devices and the members of ad hoc network 34 thus creating the expanded ad hoc network. A logical association 42 is created with all members of the ad hoc network 38 so all members of the network now become updated to the most current community server data stored on the most recently connected mobile network device that was connected to the community server.

Now referring to FIG. 3, the internal architecture of the client computational device 20A. Device 20B is identical and device 24 is a subset of 20A in terms of the content of its memory. Memory 44 is comprised of standard components typical to personal computers including, RAM, ROM, Flash and rotating media. When operating, this memory contains programs that are general to the requirements of a computer including the operating system 46. This is the main process that controls the interaction with other processes. Microsoft's Windows® is such an operating system. Remote device application 48 is a program that controls the mobile network devices through the USB connection or wirelessly through the USB access point. This client application is specific to the interaction between the mobile network device and the community server service that is being used. Client database 50 contains information that is transferred to the mobile network device when it is connected. This database is maintained while the client computing device is present on the community server through a network connection. Device gateway application 52 translates client stored database information into the format required to be stored on the mobile network device. It also creates a communication bridge that conducts transmission over the USB port. Presence engine 54 interacts with the community server to maintain a login status and identity information. Server user interface 56 is a browser such as Internet Explorer®. The browser allows the user to partake in interaction with the community server services. Network communications stack 58 establishes and maintains the TCP/IP or other network protocol connection with the mobile network server. CPU 60 operates on the memory and other peripherals to execute the programs shown and support programs. The man machine interface 62 includes the graphics display, keyboard, mouse, audio and other peripherals standard to a PC platform. A network communication interface 64 provides direct physical access to the network through an access medium such as a cable, DSL or dialup modem 68. A USB port 70 connects either directly to the mobile network device using the USB cable or wireless access point.

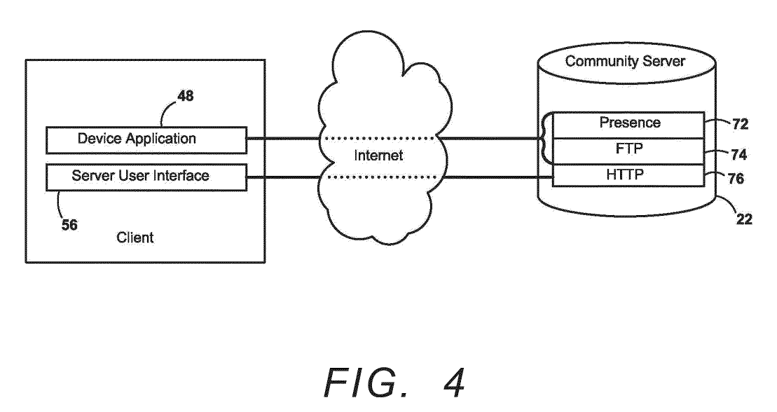

Now referring to FIG. 4, the network architecture and which data in the network server is acted upon by what part of the client side software is shown. Presence engine 72 and the file transfer protocol (“FTP”) engine 74 serve the device application. This includes creating group presence within the server community and interactions for supporting services but also dissemination of large files such a multimedia data to connected devices. Web service 76 is operated on by the server user interface.

Now referring to FIG. 5, one hardware embodiment for the mobile network device is shown. A Micro-Controller Unit (MCU) 78 executes the main application program contained in a main system memory 80. A Digital Signal Processor (DSP) 82 is connected to the MCU and acts as a coprocessor for multimedia data such as compressed audio. The connection between the MCU and DSP may be either parallel register oriented or through a serial port. The DSP is connected to a bulk storage media 84 such as nand flash memory. This stores compressed multimedia files that are decompressed and concatenated according to the application program. The uncompressed digital data is converted from digital data to analog data by analog to digital converter 85. In this embodiment that data is analog audio that is amplified by amplifier 86 and converted to audible format by speaker 88. The MCU also controls Input/Output (I/O) pins that control peripheral devices. In this embodiment an LED driver 90 drives and LED 92 in a manner that controls its brightness, on state and off state. For brevity, only one such LED is shown but any number of such devices could be driven using additional I/O ports and drivers. I/O pins also control a motor driver 94 and motor 96 in a way that the motors direction and speed can be varied. For brevity, only one motor is shown but any number of such devices could be driven using additional I/O and drivers. A sensor array 98 is connected to the MCU through I/O in this embodiment. The sensor array in this embodiment consists of a light sensor, electronic compass, ultrasonic distance sensor, sound sensor and infrared heat sensor. In other embodiments this array may vary widely including visual image recognition and voice recognition devices. A USB interface 100 allows for direct connection to the client computational device in the event that the wireless access point is not available. I/O as referenced here is not limited to digital serial or parallel and may contain combinations of both. Such examples include Pulse Width Modulation (PWM) circuits, A/D and D/A, serial Universal Asynchronous Transmitter and Receivers (UART) circuits, Pulse Code Modulated (PCM) circuits, synchronous serial ports, parallel lines under direct processor control and latched registers. A radio transceiver 102 is under control of the MCU and provides the physical link to either other mobile network devices or the client computational device if an access point is available and a USB cable is not facilitating this link. The transceiver is connected to antenna 104 to couple the transceiver signal to other transceivers that are part of the ad hoc network or to connect to the client computational device through the access point. Power supply 106 converts power forms to supply the MCU, DSP and analog circuits including the A/D and the transceiver. The power supply also isolates and filters the power forms to mitigate conducted interference between sub circuits. Alkaline batteries in series 108 are used to supply the power supply with the raw form that it converts filters and isolates. Rechargeable batteries are a clear alternative.

Now referring to FIG. 6, an alternate embodiment of the circuit shown in FIG. 5. The difference between the two is that a single processing element 110 is used to perform the same task as both the MCU and DSP in real time. A unified memory 112 is used to contain all data and program contents. In this embodiment this memory is nonvolatile consisting of rotating, flash or SRAM that is at least partially battery backed up. The processing element is highly integrated and has an onboard digital to analog converter and power amplifier that directly dives the speaker.

Now referring to FIG. 7, key components of the MCU memory. The DSP memory contains multimedia data and decoding utilities that act on that data and are controlled by the MCU that executes the device application 114 and the device database 116. A thin operating system 118 such as the commercially available TinyOS® operating system is used to manage processes and schedule events. The ad hoc network application 120 controls the logical arrangement of the mobile network device's position in the network. In the case of using TinyOS®, this application is included in the standard OS utilities. The device database contains a unique numeric or alphanumeric code that allows all devices in a network to have unique instances. Sensor control 122 is a set of algorithms specific to the particular sensors installed and allows interface and data management with the sensors. In this embodiment they service the four functions that are, to this embodiment, considered program components or events. This means that events such as sound or light detection or distance detection cause the application program to process data according to its predefined set of algorithms. A radio transceiver control algorithm 124 handles base lever RF communications including creation of data packets, bit synchronization, CRC checking, power management, frequency hop management, retry control and parsing of data. This is all done independent of the ad hoc network management.

Now referring to FIG. 8, the hardware architecture of this embodiment's network access point. This access point provides the physical RF interface to between the mobile network devices and the client computational device. It is at minimum consisting of a USB device enabled port 126. This port is directly plugged into the client computational device. In this embodiment it is shown as a different component. However, most MCU's would alternatively embody this peripheral with the exception of signal conditioning and electrostatic discharge protection devices. In this embodiment it was shown separate for clarity. MCU 128 operates with the USB device port and through it is connected to the client computing device. In this embodiment this port is used to initially mount the access port as a remote drive and auto-launch the program suite contained in its local memory 130. After launch, that program interfaces with the access point directly and enables an RF connection between the client application and the mobile network device.

Now referring to FIG. 9, a client gateway application program 132 operates in conjunction with its database 134 under the control of a very thin operating system 136. An ad hoc network management program 138 establishes the peer to peer network connections required to communicate with the mobile network devices. A radio transceiver control algorithm 140 handles base lever RF communications including creation of data packets, bit synchronization, CRC checking, power management, frequency hop management, retry control and parsing of data. This is all done independent of the ad hoc network management. FIG. 9 shows key components of the MCU memory. A client gateway application 132 controls the interface between the client computational device and the other layers of software. The device application database 134 contains an image of the client application that will be executed on the client computational device. A thin operating system 136 such as the commercially available TinyOS® operating system is used to manage processes and schedule events. The ad hoc network application 138 controls the wireless network connection with mobile network devices that are in range. In the case of using TinyOS®, this application is included in the standard OS utilities. A radio transceiver control algorithm 140 handles base lever RF communications including creation of data packets, bit synchronization, CRC checking, power management, frequency hop management, retry control and parsing of data. This is all done independent of the ad hoc network management.

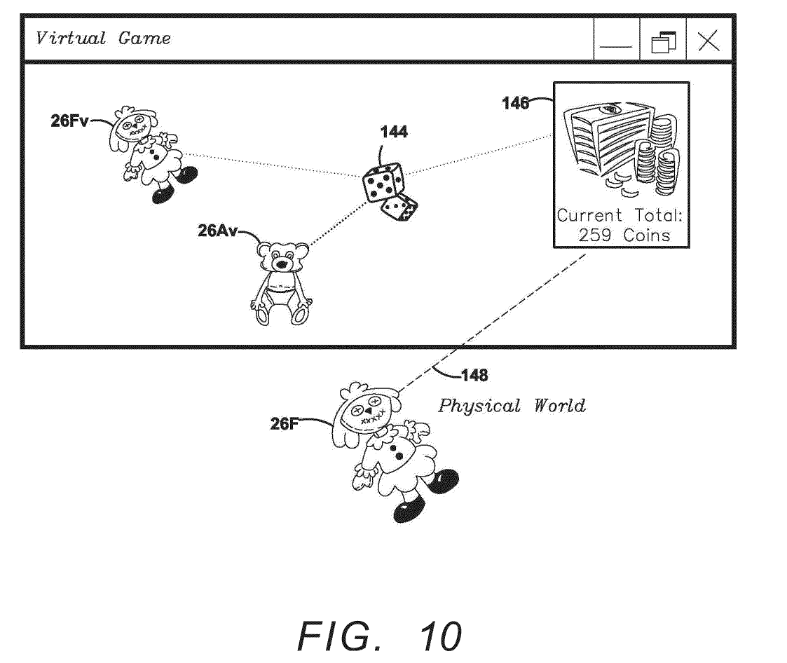

Now referring to FIG. 10, a virtual community of elements 26Av and 26Fv is shown. These elements are virtual representations of physical counterparts 26A and 26F. These virtual representations interact in a virtual game world 142. The virtual representations interact under the control of their owners by playing a multi-user game 144 by way of the community server. Credits 146 are accrued based on the merits of play and are then updated on the virtual game display. These credits are then also updated to the virtual physical counterparts over the link 148.

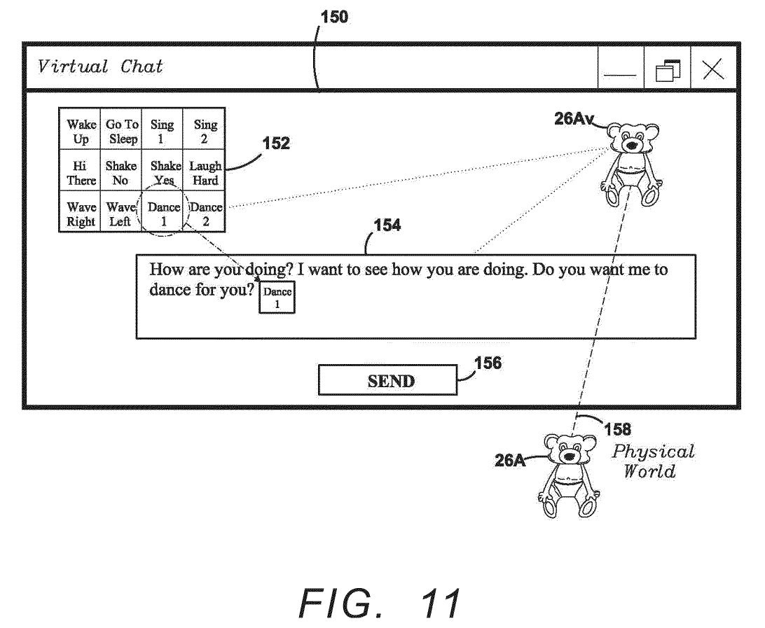

Now referring to FIG. 11, a virtual chat community 150 of virtual and physical elements, motion command emoticons 152 and a text entry field 154 is shown. The virtual elements, text entry field and command emoticons act on the physical elements when the button 156 is activated. This action is carried out by way of link 156.

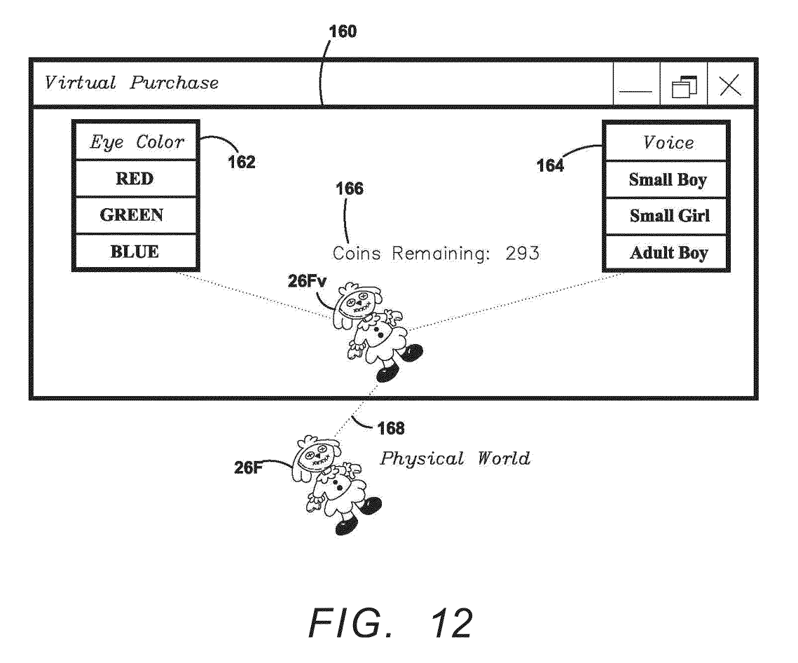

Now referring to FIG. 12, a virtual purchase community 160 comprised of virtual elements is shown. Virtual element 162 and 164 are buttons that cause an action to take place against virtual element 26Fv. Virtual element 166 is an indicator showing value decrements of those actions. The virtual actions are then updated in the physical world by way of the link.

Operation

In the embodiment detailed, users are able to interact through the community internet or closed network server 22. They either need mobile network devices such as devices 26A through 26F or 28 or they need community access through client computers 26. The mobile network devices shown are toy embodiments such as a plush or non-plush characters and hard devices with a graphics display that shows a graphical character embodiment such as a Tamagotchi®-like device. As shown, mobile devices are facilitated by the client computational devices 20A and 20B. In FIG. 1 only two devices are shown but these can be expanded as needed when new members join the community. These can be home PCs, workstations, laptops, tablet computers, smart phones or any other computational device that can bridge the mobile network device to the network. Members of the community physically acquire a network device generally by purchasing it through a physical or online distribution channel.

The user's client computational device provides presence information (presence state) via a network connection to a presence service on the community server. Their personal availability record and can be made available for distribution to other users to convey their availability for interaction. This service also facilitates real-time data transmission between members of the presence service. Status of users that wish to participate in joint server interactions are established through a unique numeric or alphanumeric digital code that is programmed into each mobile network device in nonvolatile memory when connected to a client or is programmed in the device at the point of manufacturer. This code would be used to establish the unique presence with the community server via the client application running on the client computational device or for identification with other mobile network devices in an ad-hoc connectivity situation 34 and 38 such as that shown. The mobile network devices join a server based community through a slave application running on a client computer that allows the remote network device to participate in network server interactions with multiple other community users in real-time or batched operations and store information on the mobile network device that will allow those devices to later be connected in an ad-hoc manner, independent of the server and client computer and continue interactions related to those that were originally initiated and controlled by the server. The server interactions will establish data values, rules and other information that will be transmitted to a device participating in a server activity. This information includes but is not limited to audio information, physical and logical rules for interacting (with toys specifically game play and game patterns) with its mobile network device users and other participants to an ad-hoc connection and how to process and react to sensor array information 98 and to control its input/output. Audio information can be voice, music or other sounds that can be played back based on these rules. Such rules would include, but not be limited to, greeting other ad-hoc members using voice and physical I/O operations and to exchange data amongst the ad-hoc members. In the case of a child's toy, the toys could greet each other using physical motion, audio and lighting and exchange data such as names, songs stones, physical motions such as dances and play patterns based on the servers previously established rules.

Mobile network devices that were associated to the community server at a particular point in time 36 would be updated later by an ad hoc connection with other mobile network devices associated at a later point in time 42. In FIG. 1 and FIG. 2, the ad hoc connections are shown as wireless. The hop link 40 connects one subnet consisting of the mobile access devices shown. This type of single hop connecting two subnets is generated because two groups of mobile access devices become connected because device 26A is brought within range of 26B. All devices within range will have the ability to connect with that device. The network management dynamically routes data and thus forms a dynamic network topology. This wireless connectivity can be infrared, optical, radio frequency, magnetically coupled or acoustic. Additionally, but not shown, this connectivity can also be wired. In this case the connectivity between mobile network devices would be over a serial data drop link such as RS485 or any functional equivalent. In the embodiment shown the ad hoc network is self configuring, self organizing and multi-hop. This means that unlike WiFi networks like 802.11g that require an access point to route information amongst network users, this network is true peer to peer requiring no such access point. It detects network nodes (mobile access points) as they join or leave the network and routes data homogeneously amongst all nodes. In the case of wireless connectivity, joining or leaving the network would be done by simply coming in or leaving range of a mobile network device or established ad hoc network. In the case of both wireless and wired networks this would be established by user input or the sensor array 98 status. The sensor array would contain a subset or superset of sonic distance, light, physical motion, simple switch, acoustic and electronic compass. These would influence the device application 114 in FIG. 7 according to the rules established by the community server when the associated mobile network device was associated to it. For example, mobile network devices could be instructed only to look for network members if they have been moved within a particular timeframe or detect light or sound. Examples of ad hoc network algorithms that are suitable are the Dynamic Source Routing (DSR) algorithm or the Ad hoc On Demand Distance Vector (AODV) routing algorithm. This allows mobile network device users to automatically connect with each other. An example of how this is useful is in the case of toys. Each toy that is in range of each other would detect other toys and establish a connection allowing the toys to interact and exchange data as directed by the community server when the toy was associated with it. In addition, when a user interacts with their mobile network device it will affect the status and information contained in the other mobile network devices connected to the ad hoc device. Such interaction would include game play such as following instructions to pet the toy or simulate feeding the toy. Both such actions would be detected by simple switches.

When a mobile network device is connected to a client computational device, it will add that device as a master in its network. The mobile network device or devices connected to the client will be bridged to the community server, through the client, either by a wireless access point 32 or a USB cable 30 connected to the client computational device. The protocol will be a simple serial transfer in terms of the USB connection. If a USB connection is detected by the mobile network device then that device will be controlled specifically by the client only. For wireless, the protocol will be the same as the protocol used between mobile network devices in their ad hoc mode. However, the connection will be limited to device to client. The access point, when wirelessly connected to a mobile network device or devices, will assume the unique digital code of the mobile network device sensed. When this occurs, the mobile network device or devices will create an exclusive connection to the community server via the client.

Specific operation of the access point hardware shown in FIG. 8 and its software in FIG. 9 occurs as follows. Upon inserting the access point into a client computational device the device mounts itself to the client operating system and establishes a USB connection with the client computational device. The MCU 128 handles the hardware interface through the USB hardware interface 126. This interface alternately could be integrated into the MCU itself as is often the case with most commercially available devices. Upon power up the MCU executes the contents of its memory 130. This memory contains the client gateway application 132 that is controlled by a thin operating system 136 such as the commercially available TinyOS®. This establishes the client to access point USB link. The device application database 134 contains an image of the client computation device application along with an installation utility that will auto-run if the current client computational device application is not already installed in on the client. This utility will install the gateway application on the client. This auto-run installation will execute in a manner such as AutoRun USB used by Microsoft Windows®. Another embodiment that would not have this image and installation utility would require setup on the client using a network connection or removable media such as a DVD or CD. Once physically installed and registered with the client computational device operating system, the ad hoc network application 138 and radio transceiver application 140 establish a wireless serial connection with the mobile network devices that are in range. The radio transceiver 133 via antenna 135 establishes the physical, over the air, connection with the mobile network device or devices.

The client computational device 20A and 20B as shown in FIG. 3 is at minimum a general purpose computational device that has a CPU 60 that controls all of the electrical and logical processes. The man-machine interface 62 is used to take user input of text, cursor position and commands, audio, multimedia and other physical world data and display to the user graphics, print, audio and other indicator information to the physical world. It has a memory system 44 that can be comprised of standard semiconductor devices and rotating media or only semiconductor devices. The network communication interface 64 provides the physical layer connection to the local area network. In this embodiment an 802.3 Ethernet is assumed but this interface does not have to be limited to that and may be any other network technology such as SONET or a proprietary solution. This network is then interfaced with a network connectivity device 68 such as a cable modem, hub or router that connects to the main LAN or internet. The USB interface 70 plugs into the access point, supplies the access point with power, controls its status and passes data over it to the mobile network device or devices. This port is a host port. Upon boot up, the operating system 46 is executed by the CPU. The operating system controls all other logical processes through the CPU. The remote device application 48 is registered to the operating system and is executed. This application handles the interface between the USB access point or USB cable. It automatically detects the presence of unique mobile network devices and establishes a logical and physical link with them. This is a background process and requires no user interaction. The device gateway application 52 operates the low-level communications with the access point, or the directly connected via USB cable, mobile network device and provides a unified interface to the remote device application. The presence engine 54 is slave to the remote operating system but controlled via the operating system by the remote device application. Under this control, a presence on the community server is established using the unique device identifier. Real-time data is also routed through this application. The presence on the server is related to the unique code programmed into the mobile network device. The community server is acted upon by the server user interface 56. This interface in this embodiment is a web browser such as Microsoft Internet Explorer®. This also could be any other unique application such as a 2D or 3D game or control panel. This application can be installed on the client or can be downloaded to the client at runtime. The user may also interact through more that user interface. For example, it the case of a downloaded game, the user sill may interact with the server using Internet Explorer® for game setup, accounting and control. The device database 50 is stored locally on the client. This allows for caching of data that is to be uploaded to a mobile network device or downloaded to the community network server. This allows users to interact with the server when a mobile network device is not present or turned on. It also allows for the converse. If a user wished to interact directly with their mobile network device when not connected to the server they may do so. The network communications stack 58 provides the interface between the network and the operating system. The remote device application, device database, device gateway and presence engine are installed by the access point when first plugged in to the client USB port or by a separate peripheral media source. The user access interface client 24 is a subset of the client application. It does not require the USB port and associated software, however.

The community server maintains and provides services for the client computers. FIG. 4 shows the data flow interaction of the key services and controlling client applications. When the user starts up the client, the remote device application 48 gains control of the background processes and the server user interface 56 allows interface between the user and community server. In a simple application, where a web based game was being played for example, the client only uses a network browser to access the server. The browser would interface over the network to an HTTP service 76 on the community server and would provide the gaming interface. The remote device application would then create the server presence on the server presence service 72 and handle any large file uploads and downloads using the server FTP service 74. These files include multimedia files and new versions of application programs. The presence service would also facilitate real-time data transactions in response to input to the server user interface. As mentioned, the server user interface is not limited to a browser. Hence, in other embodiments the server user interface may also directly communicate with the server presence engine and the FTP service directly. The architecture shown is merely one such logical arrangement.

The mobile network devices described in this embodiment has the hardware architecture as shown in FIG. 5 and FIG. 6. The software architecture is shown in FIG. 7. The batteries 108 are used to independently power each device. When connected, the power supply 106 will constantly be provided with a voltage and current source from them. The power supply converts the power to the forms required by the rest of the circuit. It also provides a power-on and power-off reset that prevents erratic behavior when the batter power is removed or droops below range. A low voltage indicator is also provided by this circuit to the MCU to warn the user of impending battery failures. The batteries may be rechargeable or one-time use. Power on and off is accomplished by a switch (not shown) that interrupts the battery connection to the power supply. Alternatively, an I/O event may also be used to bring the unit out of a deep sleep that would provide extended battery life and the user perception of being powered off in terms of battery life and function. Upon any power up event, the MCU 78 and DSP 82 initialize and begin running the program code in the associated memories 80 and 84. FIG. 7 shows the key software components of the MCU memory. Data transactions conducted through the antenna 104, through the radio transceiver 102 and through the MCU form the conduit for data that is initially stored in main system memory. Specifics of this connection are transparent to the user and form an ad hoc network connection with all other remote network devices in range. The USB port 100 is used for connection to the community server via the client computational device. When connected, the server will instantiate the specific mobile network device connected into the virtual community interaction or service requested by the user. In the case of a toy game connected to a Massively Multiplayer Online service, the presence of the device, either through a wireless connection or USB connection with the client, will instantiate that device within that game. In the case of a MMO game, instantiation of a mobile network device would cause a logical avatar to enter that game. This avatar would be unique and posses the characteristics earned through game play and through user interaction directly with it. Based on the rules and algorithms established by the community server, the MCU interacts with its peripherals accordingly. The sensor array is connecting by either analog (via an MCU resident A/D or A/D and D/A), serial or parallel means and is monitored on a polled or interrupt basis by the MCU. Response to the sensor array stimulus is handled by the MCU in accordance to the algorithms and rules set forth by the mobile network device application. An example of this would be waking up from a deep sleep mode when a switch is closed. Another would be to wake from a deep sleep when light is sensed. In terms of a digital compass in a toy, the toy could provide instructions on which way to face it to watch the sun rise or set. The motor or motors 96 are driven by a driver circuit using an H-bridge arrangement in this embodiment. This H-bridge is also driven by a pulse width modulated signal that is integrated at the output. This allows for both speed and direction of the motor to be controlled. More independent motors for different embodiments would require independent drivers. A simple embodiment could also use a device as simple as a single FET or transistor for only on or off control. The motor in this case could be used to run simple actuators such as a vibrator or fan. The H-bridge design can control independent gear motors that would provide complex robotic joint motion. Independent motors require independent drivers. In this embodiment the motor drives a cam and switch mechanism that allows for multiple actions by reversing and advancing the motor and sensing the cam mechanism's position with simple switches. This is commonly used in simple robot toys to provide motion of various features such as eyes, feet and vibration based on the mechanism's capabilities. Other user interface is done through LED indicators. In the embodiment shown, one LED 92 is shown; however, other embodiments may have none or many. Independent LED or serial connected LEDs would require independent drivers. This embodiment uses a PWM based driver 90 that is current amplified to drive one or more LEDs in serial configuration. This allows for variable intensity of the LED. Because of the logarithmic nature of human sight, the drive would provide a logarithmic intensity pattern so the MCU device application program would be presented with a perceived set of linear brightness values in terms of human sight. In the embodiment described the LEDs would be used to impart information by intensity. In a toy application this could be used for feature enhancement such as eyes. If multiple channels are used, one for a red LED, one for a green LED and one for a blue LED then these channels could be optically combined to provide a large spectrum of light. In case of a toy, this would allow the eyes to be red for anger and green for calm. The DSP 82 in this embodiment implements audio decoding of data stored in compressed format in its memory. This memory contains data compressed in OGG or any other equivalent format such as MP3. Under command of the MCU, segments of audio are accessed from the DSP memory and played back. This audio can be music, voice, abstract sounds or any other audio emission. The audio can also be segmented and reconstructed or stored in text format that is later converted to speech. Once the audio is accessed and decoded it is exported to an audio analog to digital converter 85 and then amplified so that the speaker 88 can reproduce the audio. In a toy embodiment, this audio could represent music and speech that would describe the online experience, announce itself using its name and any other play pattern related noises that are downloaded by the community server or by interaction with other remote network devices. In an expanded embodiment, this DSP could also act as a full multimedia CODEC that could handle not only audio but video and other data. Sensors such as a microphone and image sensor would need to be added and connected to the DSP in this case as well to support this expanded embodiment. In the case of the graphic oriented mobile network device 28 a graphics display such as an LCD would be added and connected into an available serial or parallel buss. This was not shown but would be part of the embodiment of such a device. FIG. 6 is functionally identical to the implementation of FIG. 5. However, the USB port has been removed and the functions of the MCU and DSP have been integrated into one system on silicon device 110. Such device can consist of a single processor or multi-processor core but are in either case capable of implementing all functions of the MCU and DSP pair in FIG. 5. System memory 112 would also contain the programs resident in the main MCU memory and the decoder or CODEC in the DSP memory. In either case, the processing device or devices implement the core functions of the user experience through the communications with the client through the direct USB connection with the client via the community server.

The user experience using this embodiment is best explained in FIG. 10, through FIG. 12. After a user purchases a mobile network device they are able to interact with that device immediately after it is powered on. No client device is needed for the user to interact with it. In the case of using this embodiment as a toy, it would allow the user to interact with it in response to sounds and voice commands. Similar to a Furby, user feedback would be required. Within the game play, however, the user would be audibly or audibly and visually prompted to go online and register their product and join game and other community services on the server. Also, when brought into range of other remote network devices the user's device would learn other data from those devices through the ad hoc network. Such data would include the dolls name, current standing in the community, favorites, age and many other game oriented and community oriented information. The device would then prompt the user to go and join the online community if they have not already done so. When online in a toy community, FIG. 10 shows a simple schematic of an online game 144 played in a web browser window 142. The game would be played on a turn-based basis between one virtual community member 26Fv and at least one other virtual member 26Av. Some games naturally would allow single user play and others would allow many users to play together either as teams or individually such as in existing massively multiplayer online (MMO) games do now. In the simple game shown, an account of credits or game currency 146 is accrued based on the results of the game for the user. These credits along with other game results, including new member names and data that you have met online are then updated to the user's mobile network device through the client using the means already described. For illustration, on update there is a logical connection between game results 148 that are created between the community server contained results and the player's mobile network device 26F. Instantiation of the players in a particular game would require the logical presence of the mobile network device or an equivalent login using a client interface. For example, if a user attaches a mobile network device to the client gateway it automatically generates a logical presence on the server and hence in the virtual world. If the mobile network device is not present or the user logging in does not have theirs, they still could use a client interface device to participate in the online community. A login and password would be required in this case. When they did connect their mobile network device to the community server, then the client application would synchronize the data on the server with the associated mobile network device. If a user does not have a mobile network device when they first establish a presence in a virtual community and they later purchase one, they may associate and synchronize their data on the mobile network device with the virtual character they created online. In the case of a toy doll, the user would login to the community and create a virtual doll. They could then participate in community interactions with their virtual doll. If they later acquire a physical device and connect it to the server via a USB cable or wireless connection to a client computational or interface device, the physical device associated with the virtual character will synchronize its data with the physical one. Conversely, when a physical device is interacted with either by another device when it is in an ad hoc connection or when the user interacts with the device alone, the results of that interaction are updated to the associated server service when the device gains a connection to it. An example would be the doll like device. It can verbally prompt its user to perform tasks with the doll or other dolls if in an ad hoc network. The results of these tasks would be acknowledged using the sensor array and would be stored locally on the doll. These results would then change the virtual version of the doll online the next time a connection with the server was created.

Another business aspect of having the mobile network device be able to respond to user interaction and prompt the user to go on line is to draw the user to particular web sites capable of generating tangible commercial value. These sites could sell both physical and virtual accessories for mobile network devices. In the case of a doll, virtual accessories could be new physical motion, action and multimedia accessories including music. Physical items could be tried on in a virtual world. Once they were purchased they would become part of the virtual character immediately and would be shipped out to match up with the physical devices at a later date. These would be sold online or could be purchased as certificates or items at stores.

Other than just participating in games mobile network device users may use numerous other services from the community server. Additional examples are shown in FIG. 11 and FIG. 12. In FIG. 11 a virtual chat window 150 is shown in a web browser. This chat allows for a community member to login to another community member's common virtual space on the server and send messages. These messages are multimedia. They can be created by typing text into a text field 154 and dragging emoticons from a group of emoticons 152 into this field and interspersing them within the text. A specific mobile network recipient 26Av is selected and instantiated in the virtual environment prior to sending any messages. This virtual mobile network recipient is associated with a corresponding physical device 26A through a logical connection 158 with the community server. When the send button is pressed the contents of the field are sent to the community server. If the associated physical world mobile network device is logically connected to the server, the contents are received by that device. The text is translated into speech. The emoticons are synchronized with the text based on their placement within the text field. Emoticons in this field cause physical action to occur in the physical world device 26A. These actions may be synchronized with their own audio or may be timed with the playback of the text to speech. The point at witch the text is translated to speech can be anywhere along the logical chain. This will not affect the final result. An example of emoticons that are sent with audio attached would be a dancing emoticon. The audio would be a song and the motion would be synchronized or at least played back during the length of the audio. An example of emoticons that are synchronized with the text would be a shake head no emoticon. It would cause the robot to repeat the shake head no action until the end of text is met or until another emoticon is met. Some emoticons can be for control purposes only as well. One example would be a terminate action emoticon. It would work with an emoticon such as the shake head no emoticon. If a user wishes to simply stop an action after a certain length of playback they would embed that emoticon in the text at the point in the replayed speech pattern where the user whishes the action to stop.

FIG. 12 is a browser window 160 illustrating a purchase of virtual goods. Users may use select a virtual avatar of a mobile network device 26Fv in the virtual world and instantiate it in the browser space. A buddy list could be used to select the device in the community to be instantiated. The virtual device can then be changed with the purchase of virtual products. As shown, the eye color 162 can be changed along with enhanced voice tone 164. This would be done simply by pushing the associated button. Each such operation would change the virtual instantiation of the device and would also affect the physical device 26F when it is connected to the community server either at the time the purchase was made or the next time it is connected if it was not when the purchase was made. For example, if the eye color is changed from red to green in the virtual field, the LEDs driving the eye color would correspondingly change (assuming a 3 channel RGB light source). Purchases would in this example decrement a previously accrued account 166 that is tracked by the server. The display in the example is a simple titled field. Physical purchases of items such as has, clothing, protective sleeves and other accessories can be made this way. First they would be examined by the user in the virtual world in use. They would be able to see the virtual device using that item. If they were satisfied they could then purchase, using real monetary instruments not virtual ones, that item. The virtual character would immediately be affected by this. The actual physical item could later be sent out by a physical world store through a shipping service so it could be used with the virtual character's physical counterpart.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described apparatus. Thus, the spirit and scope of the invention should be construed broadly as set forth in the previous specification or appended claims.

What is claimed is:

1. A system for creating an ad hoc network between mobile devices comprising:
a plurality of independent mobile network devices that have been previously associated with a community server wherein the community server stores information and exchanges the information across a link to the network devices;
at least one network protocol to be used between the network devices;
a unique identifier assigned to each of the network devices and the community server;
a variety of commands stored on either the network devices or the community server; and
a virtual interface designed for utilizing the commands and controlling the network devices.
